(19) United States
(12) Patent Application Publication
(10) Pub. No.: US 2009/0258125 A1
(43) Pub. Date: Oct. 15, 2009

(54) Ozone Emitter, Method and Equipment for Producing the Ozone Emitter, and Method for Utilizing the Same

(75) Inventor: Tomoaki Akiyama, Fukuoka (JP)

Correspondence Address: JORDAN AND HAMBURG LLP, 122 EAST 42ND STREET, SUITE 4000, NEW YORK, NY, 10168, US

(73) Assignee: ICEMAN CO., LTD., Kurume-shi (JP)

(21) Appl. No.: 11/992,865

(22) PCT Filed: Sep. 28, 2006
(86) PCT No.: PCT/JP2006/319336

§ 371 Date: Mar. 28, 2008

(30) Foreign Application Priority Data
Sep. 28, 2005 (JP) 2005-283049
Nov. 21, 2005 (JP) 2005-335216
Jul. 28, 2006 (JP) 2006-205854
Aug. 11, 2006 (JP) 2006-219513

(51) Int. Cl. A23L 3/3409; C01B 13/10; B01J 19/08; B65D 81/20; B67D 5/00

(52) U.S. Cl. 426/320; 423/581; 422/186.12; 206/524.4; 222/3

(57) ABSTRACT

The present invention provides an ozone emitter, which can continue to emit ozone gas for a long time, which can continue to exert effective detergent and bactericidal action due to ozone gas for a long time, and which is easily portable, a method and equipment for producing the ozone emitter, and a method for utilizing the same. The ozone emitter is provided in such a manner that ozone gas is filled into a container which is obtained by forming an ozone gas impermeable film material in a container shape, wherein the film material is provided with a number of fine permeable pores through which molecules of ozone gas can permeate.

### BACKGROUND OF THE INVENTION

1. Field of the Invention

The present invention relates to an ozone emitter which can sterilize food products such as fresh food of which the freshness must be preserved, instruments such as medical devices for which prevention of bacterial and viral infection is required, and the like for a long time, and more particularly to a method and equipment for producing the ozone emitter, and a method for utilizing the same.

2. Description of the Prior Art

Generally, if agricultural products such as vegetables are distributed in their natural states as in harvesting, the freshness can not only be easily preserved, but also the products are safe. However, it has often been the case recently that vegetables and the like are precut to a certain size and distributed in the form of precut vegetables. In this case, there is a problem in which unwanted bacteria invade from the cut area of the vegetable to accelerate decay. In such a distribution pattern, it is imperative to wash and sterilize the cut area and the like of the vegetable with chemical additives such as sodium hypochlorite solution. However, in the case where a sterilizing treatment is conducted using such chemical additives, there is a risk in that the chemical remains on the vegetables and has an adverse affect on the human body.

In recent years, in the detergent and sterilizing treatment of the fresh food such as fish and seafood, animal meat, vegetables and fruit, use of ozone gas in place of the chemical additives has come under view. Ozone has been used in the washing and sterilizing operation and room sterilizing because it is an ideal bactericidal substance which exhibits strong sterilizing power and becomes oxygen and is detoxified after action.

It is however difficult to keep the ozone in the air because of its active autoproteolysis and diffusion. Thus, in order to utilize ozone gas for a long time, there is only one way whereby ozone is obtained by activating an ozone generator at a location where ozone gas is needed. However, in such a way, when sterilizing is conducted in transport and the like of food products, it is hardly practical to use the ozone generator because the ozone generator itself must be carried about and ozone gas must be continuously filled into a container in which food products to be sterilized are contained. To solve such a problem, a freshness-keeping method has been suggested whereby a film ice-coated by ozone is formed on the surface of fresh food to preserve the freshness (e.g., refer to Patent Document 1).

Patent Document 1: Japanese Unexamined Patent Publication No. 2003-169645

However, the freshness-keeping method as disclosed in Patent Document 1 is limited to an object which can be exposed to water because ozone water in which ozone gas is dissolved in water is frozen to form an ice coated film. Further, the concentration of ozone gas which can be used directly on the fresh food is several ppm and an ozone gas at a concentration of several ppm can remain for only 10-20 minutes in a condition in which the gas is dissolved in the water for several tens of minutes. In this manner, there is a problem in which bactericidal action can be expected for only a short time and a high action effect cannot be obtained.

### SUMMARY OF THE INVENTION

It is therefore an object of the present invention to solve the problems described above and provide an ozone emitter, which can continue to emit ozone gas for a long time, can continue to exert effective detergent and bactericidal action due to the ozone gas for a long time and is easily portable, and to provide a method and equipment for producing the ozone emitter, and a method of utilization thereof.

(1) First aspect of the present invention: To solve the problems described above, an ozone emitter formed by filling ozone gas into a film container which is obtained by forming an ozone impermeable film material in a container shape is provided, in which the film material is provided with a number of fine permeable pores to cause the molecules of ozone gas to permeate.

(2) Second aspect of the present invention: The ozone emitter according to the first aspect is provided, in which the film container is a container of which the internal volume is 1 cc˜1000 cc and in which ozone gas with a concentration of 1000 ppm˜10000 ppm can be contained.

(3) Third aspect: The ozone emitter according to the first aspect of the present invention is provided, in which the film container is composed of at least one or more cells.

(4) Fourth aspect: The ozone emitter according to the third aspect of the present invention is provided, in which the cell has a capacity of 1 cc˜50 cc per unit.

(5) Fifth aspect: The ozone emitter according to the first aspect of the present invention is provided, in which the thickness of the film material is 10˜100μ.

(6) Sixth aspect: The ozone emitter according to the first aspect of the present invention is provided, in which the film material is a plastic film material of which the main ingredient is at least one of polypropylene, polyethylene, polyvinyl chloride and polyester.

(7) Seventh aspect: The ozone emitter according to the first aspect of the present invention is provided, in which the film material is a single layer film material or a multi-layer film material laminated with at least two or more film layers.

(8) Eighth aspect: The ozone emitter according to the first aspect of the present invention is provided, in which the diameter of the permeable pores formed on the film material is 5˜50μ.

(9) Ninth aspect: The ozone emitter according to any one of the third through eighth aspects of the present invention is provided, in which the film material forming the cell is provided with 1˜100 units of permeable pores per 1 cm².

(10) Tenth aspect: a method for producing an ozone emitter is provided, which comprises the steps of: generating ozone gas; forming a film material with permeable pores, obtained by providing a film material with fire permeable pores, in a container shape and forming at least one or more cells on the film material with permeable pores; and filling the ozone gas generated by the ozone generating step into the cell formed by the container forming step at a pressure substantially equivalent to atmospheric pressure.

(11) Eleventh aspect: A method for producing an ozone emitter is provided, which comprises the steps of: generating ozone gas; forming fine permeable pores on a film material; forming a film material with permeable pores formed by the permeable pores forming step in a container shape and forming at least one or more cells on the film material with permeable pores; and filling the ozone gas generated by the ozone gas generating step into the cell formed by the container forming step at a pressure substantially equivalent to atmospheric pressure.

(12) Twelfth aspect: Equipment for producing an ozone emitter is provided, which comprises: a forming machine for continuously forming the film material with permeable pores in a container shape; an ozone generator for generating ozone from oxygen in the air; and a filler provided with a nozzle for automatically filling and hermetically sealing the ozone gas generated by the ozone generator into a film container formed by the forming machine at a pressure substantially equivalent to the atmospheric pressure.

(13) Thirteenth aspect: The equipment for producing an ozone emitter according to the twelfth aspect of the present invention is provided, in which the forming machine is provided with a perforator for perforating fine permeable pores into the film material to form a film with permeable pores.

(14) Fourteenth aspect: The equipment for producing an ozone emitter according to the twelfth aspect is provided, in which an end of the nozzle of the filler to be inserted into the film container for filling ozone gas is formed in an ellipsoidal shape or a flat shape of which both ends are shape at an acute angle, in section.

(15) Fifteenth aspect: The equipment for producing an ozone emitter according to any one of the twelfth through fourteenth aspects of the present invention is provided, in which the forming machine is provided with a sealing device which can continuously form the film material with permeable pores of which the thickness is 10˜100μ in a container shape, and the sealing device can form at least one or more cells on the film material with permeable pores formed in the container shape.

(16) Sixteenth aspect: A method for utilizing an ozone emitter is provided, whereby the ozone emitter according to any one of the first through eighth aspects of the present invention is utilized as a buffer material in transport.

(17) Seventeenth aspect: A method for utilizing an ozone emitter is provided, whereby the ozone emitter according to the ninth aspect of the present invention is utilized as a buffer material in transport.

### BRIEF DESCRIPTION OF THE DRAWINGS

The above and other objects, features and advantages of the present invention will become more apparent from the following description when taken in conjunction with the accompanying drawings.

FIG. 1 is an explanatory view showing one embodiment of an ozone emitter according to the present invention;

FIG. 2 is an explanatory view showing another embodiment of the ozone emitter according to the present invention;

FIG. 3 is an explanatory view showing another embodiment of the ozone emitter according to the present invention;

FIG. 4 is an explanatory view of yet another embodiment of the ozone emitter according to the present invention;

FIG. 5 is a flow chart showing a production process for the ozone emitter according to the present embodiment;

FIG. 6 is an explanatory view showing all the production equipment for the ozone emitter according to the present embodiment;

FIG. 7 is an explanatory plan view showing part of container production equipment of the ozone emitter production equipment according to the present embodiment;

FIG. 8 is an explanatory side view showing part of the container production equipment of the ozone emitter production equipment according to the present embodiment;

FIG. 9 is an explanatory front view showing part of the container production equipment of the ozone emitter production equipment according to the present embodiment;

FIG. 10 is an enlarged explanatory plan view of part of the container production equipment of the ozone emitter production equipment according to the present embodiment;

FIG. 11 is an enlarged explanatory front view showing part of the container production equipment of the ozone emitter production equipment according to the present embodiment;

FIG. 12 is an explanatory view showing a perforator of the ozone emitter production equipment according to the present embodiment;

FIG. 13 is an enlarged explanatory view of a surface section X of a porous roller which is provided in the perforator as shown in FIG. 12;

FIG. 14 is an explanatory view showing an embodiment of a test in which an ozone emitter according to one example is used;

FIG. 15 is an explanatory view showing an embodiment of a test in which an ozone emitter according to one example is used;

FIG. 16 is a view showing measurement results of a test in which an ozone emitter according to one example is used; and

FIG. 17 is an explanatory view showing an embodiment of an ozone emitter according to one example.

### DETAILED DESCRIPTION OF THE PREFERRED EMBODIMENTS

An ozone emitter according to the present invention is provided in such a manner that a number of fine needle's eye shaped permeable pores are perforated in an ozone gas impermeable film material to form a film material with permeable pores, and the film material with permeable pores is then formed in a container shape having at least one or more cells. Ozone gas at a high concentration is then filled and hermetically sealed into the cells of the container. The ozone emitter is provided to cause ozone gas housed in the cell to permeate through the fine permeable pores formed in the film material in an adequate amount so that the ozone gas can be continuously emitted for a long time.

It takes time for the ozone of high concentration to be decomposed to change to oxygen. Accordingly, the ozone can remain in a film container for a long time, and as a result, the film container can continue to cause ozone to emit through the fine permeable pores. It is known that it is difficult for ozone gas to be decomposed if in a dry form and in high concentration. In this manner, by filling ozone gas into the film material in such a dry form, it is possible to continue the condition, in which the ozone gas is in high solution, for a very long time and to cause ozone gas to be continuously emitted through the permeable pores for a very long time.

In order to cause ozone gas of a high concentration suitable for sterilizing to continuously permeate outside the film container for a long time, the concentration of ozone gas to be filled into the present ozone emitter is set at about 1000 ppm˜10000 ppm. It is dangerous for humans to directly inhale such ozone gas of high concentration. However, by filling the ozone gas into the film container and causing a minute amount of ozone gas to permeate through the permeable pores of the film container, the concentration of the ozone gas to be emitted is controlled as low as possible to assure safety. Even in the case where the film container is broken, in order not to cause the ozone to be discharged from the film container all at once, the film container is provided with at least one or more cells, preferably 1˜20 cells and ozone gas is filled separately into these cells. The capacity of each cell is set at 50 cc or less and the total amount of the emitter is set at 1000 cc or less at most to assure safety.

Teflon (registered trademark) is also available as the film material for forming the film container because ozone gas penetrates Teflon with difficulty. However, since the duration of action during which the ozone emitter is expected to emit ozone gas is two days or so at longest, it is not necessary to use such a high-priced material, but it is desirable that an easily-obtainable low-priced plastic film such as polypropylene, polyethylene and polyester be used to reduce the cost of the film material. It is also desirable that the thickness of the film material be about 20˜100μ, more preferably, 30˜60μ taking strength into account. It is to be noted that strength of the film material can be secured by forming it in a multi-layer film material of two or more film layers by laminating the plastic films described above or in a multi-layer film material by laminating metal on the plastic film, or in a multi-layer film material by depositing metallic components on the plastic film.

If permeable pores of a diameter of 5˜50μ, more preferably, of 15˜30μ are perforated in the film material to be uniformly distributed to the extent of 1˜100 units per 1 cm², more preferably, 10˜50 units per cm², an expected amount of ozone permeation can be obtained. By hermetically filling ozone gas into such a film container at a pressure substantially equivalent to atmospheric pressure, it is possible to provide an ozone emitter which can continue to emit ozone gas of a suitable amount and a suitable concentration from the permeable pores for a long time. If such an ozone emitter is used in transport of fresh food, fruit and the like, it is possible to transport and preserve these unsterilized objects while effectively sterilizing them. Further, if the ozone emitter is packed and shipped together with these objects, it can also be used as a buffer material.

The ozone emitter according to the present invention will now be described in detail.

Ozone of a high concentration of 1000 ppm˜10000 ppm is filled into a bag made of a film material with permeable pores to provide an ozone emitter, which is housed in a sealed container together with fresh food, fruit and the like which require sterilizing. The sterilizing condition in the sealed container can be maintained for a long time because an adequate amount of ozone gas is continuously emitted from the permeable pores of the ozone emitter. Since the ozone in the container is replaced by and mixed with the outside air, the container is not flattened as gas is emitted and thus, it is not necessary to apply pressure on the inside of the bag.

Further, when the ozone emitter is formed by a film container of a large-capacity, a large amount of ozone gas is emitted if broken. Since it is dangerous if the large amount of ozone gas is inhaled into the human body, the capacity of one film container is set at 1000 cc or less, at most. The film container is also provided with a number of partitions to provide a number of small chambers, i.e., cells. With this arrangement, even though the film container is broken, it is possible to prevent the total amount of ozone gas contained in the film container from being emitted. Thus, the film container is designed to cause part of the ozone gas to discharge.

Preferred embodiments of the present invention will now be described with reference to the accompanying drawings.

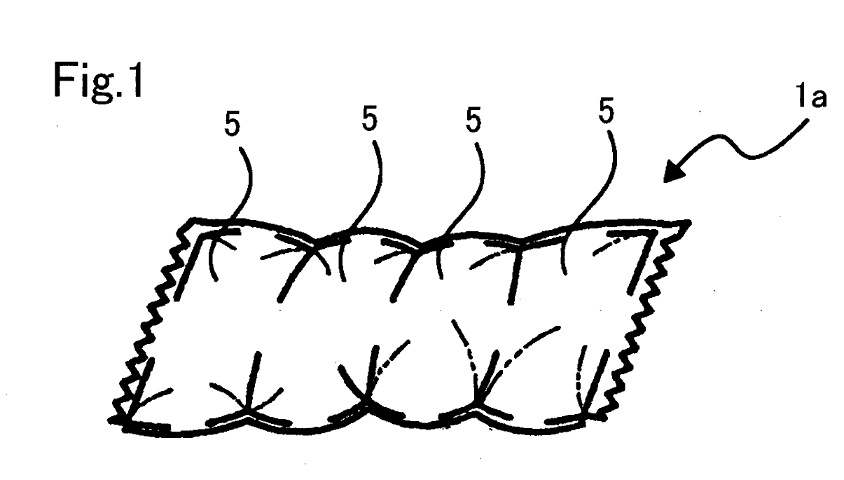

FIGS. 1 through 4 are perspective views showing one embodiment of the present ozone emitter, respectively. In an ozone emitter 1a as shown in FIG. 1, a film container is provided with a number of cells, here, four cells 5, so that the ozone gas contained in the film container can be separated into discrete amounts.

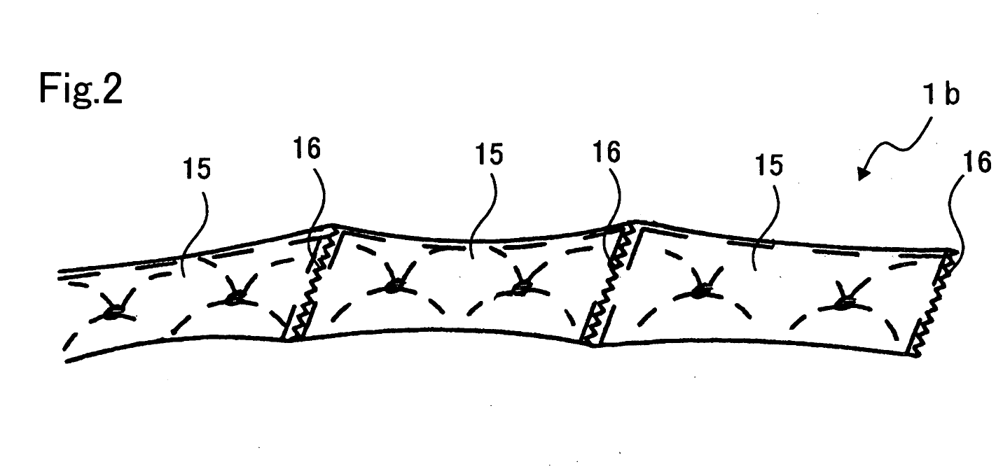

Each cell is made small to have the capacity of about 1 cc˜50 cc. This is to prevent a large amount of ozone gas from being discharged even though some of the cells are broken, wherein the emitted ozone gas is diffused in the air to be soon decomposed. An ozone emitter 1b as shown in FIG. 2 is provided with perforated lines 16 between each cell 15 so that a film container can be separated from the perforated line 16 in units of a number of cells 15. If the ozone emitter 1 of such a shape is properly filled into a space between the objects to be shipped, it can be effectively used as a buffer material for maintaining a bactericidal effect.

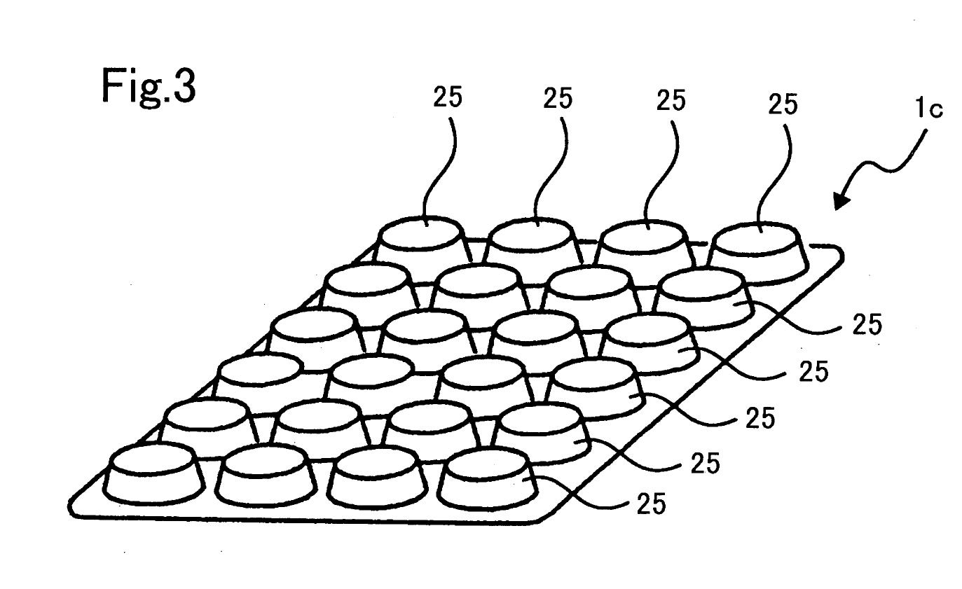

As shown in FIG. 3, an ozone emitter 1c can also be made by a film container of a shape such as a PTP (press through package) for medications. Such an ozone emitter 1c is provided with a number of cells 25 of a capsule shape like a medicine tablet. Perforated lines (not shown) can also be provided between the cells 25, from which each cell 25 can be detached. In such a composition, if the cell of which one side is made convex is formed of a plastic material through which ozone gas can not permeate and the other side of the cell is provided with an ozone permeable material, the danger of emitting ozone contained in all the cells at the same time can be further reduced. This may be a suitable form for use in small quantities.

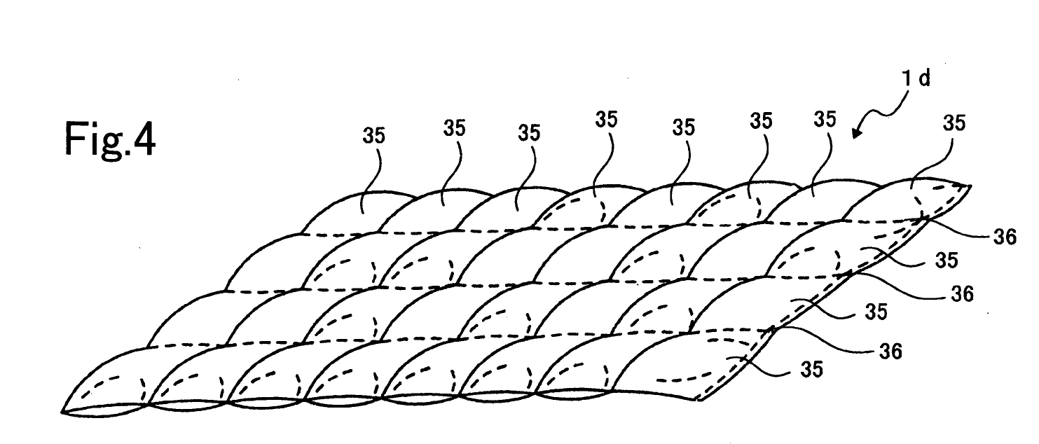

Further, as shown in FIG. 4, an ozone emitter 1d can be formed in a sheet shape so that it can be readily housed in a container box together with unsterilized objects. In this case, the ozone emitter 1d can serve as a buffer material in a container in the transport of, for example, vegetables and fruit and can be used more effectively. In such a sheet-shaped film container, if perforated lines 36 are provided at the connecting sections of each cell 35, the necessary amount of ozone emitters 1d can be cut along the perforated lines 36.

Although not shown, the ozone emitter 1a as shown in FIG. 1 can also be sealed within a pack to provide an ozone emitter which can improve the storage stability of ozone. With this arrangement, it is possible to provide an easily portable ozone emitter which is readily available and which can immediately emit ozone once unpacked at the location where the ozone emitter is to be used.

It is not necessary to make the pressure within the film container in which ozone gas is filled higher than the atmospheric pressure. However, if it is required to immediately emit ozone gas from the ozone emitter, it is possible to fill the ozone gas into the container under a slight pressure or to force the ozone emitter to emit the ozone gas due to inner pressure by putting dry ice and the like into the film container. If the ozone gas to be filled has a concentration of about 1000˜5000 ppm, the concentration is reasonable judging from the ease of ozone gas production. However, ozone gas of higher concentration, for example, of about 5000˜10000 ppm, or ozone gas of lower concentration can be filled into the film container depending upon the type of objects to be sterilized. In this manner, it is necessary to fill the ozone gas of optimum concentration into the film container depending upon the objects to be sterilized, the capacity of the sealing container, and the like.

Referring to the duration of action of the ozone emitter, it will be satisfactory to have such duration of action as to be capable of covering the transit time. It is therefore not necessary for the film material to have long-term resistance properties to ozone gas. Accordingly, a material with high resistance to ozone such as Teflon (registered trademark) can also be used, but if a lower-priced plastic film such as polypropylene, polyethylene, polyester and polyvinyl chloride is used, it is possible to form a low-priced and more adequate film material. Sufficient strength of the film material is secured by laminating the film material in multi layers, for example, by laminating these plastic films in two or more layers, by laminating metal of the thickness of 5˜10μ on these plastic films or by depositing metallic components on these plastic films. It is desirable that total thickness of the film material be 10·100μ, but if the thickness of the film material is 25˜60μ, production of the film material will be easier and more desirable.

The diameter of permeable pores formed on the film material is 5˜50μ, and more preferably, 15˜30μ, to cause the molecules of ozone to permeate through these extremely fine permeable pores. The ozone molecule itself is extremely fine, the distance of ozone between atoms being 12.78 nm, the molecular weight 48, and the size about 20 nm.

It is desirable that the number of permeable pores perforated in the film material be 1˜100 per 1 cm², and more preferably, about 1˜50 per 1 cm². It is to be noted that if the density of perforated pores is too high, tensile strength of the film itself becomes low and undesirable, while if the density of the pores is too low, it is difficult for the ozone gas to properly permeate through the pores. It is therefore desirable that the film material with permeable pores be perforated within the scope described above.

Basically, gas is permeated through materials such as metallic foil and plastic film with difficulty. In order to cause ozone gas to permeate through these materials, a perforation process is required to form fine pores. Various means are available for such a fine pores processing technique. For example, a physical perforation method utilizing mineral crystals and a chemical perforation process can also be adopted. The quality of material for forming the film material is not limited to the above if the conditions, in which fine perforation process can be made and the film material is not invaded by ozone and the like, are met.

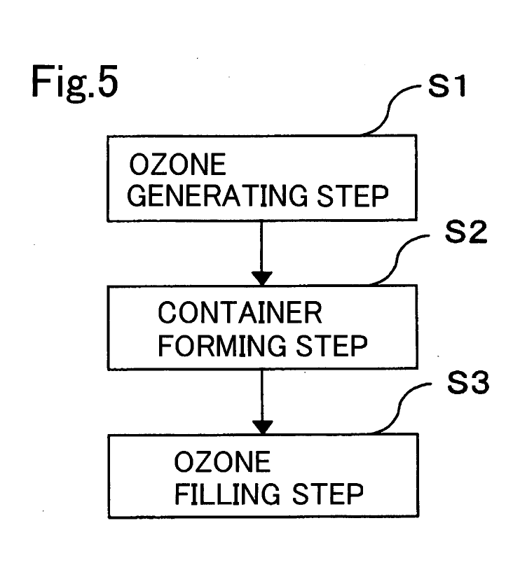

FIG. 5 is a flow chart showing a main flow of a method for producing the ozone emitter. As shown in the figure, an ozone emitter according to the present embodiment is produced through the following steps: an ozone generating step S1→a container forming step S2→an ozone filling step S3.

In other words, the method for producing the ozone emitter comprises: an ozone generating step S1 for generating ozone; a container forming step S2 for forming the film material with permeable pores, in which permeable pores are perforated, into a container shape and for forming at least one or more cells; and an ozone filling step S3 for filling ozone gas generated in the ozone generating step S1 into the film container formed in the container forming step S2.

Although described later, in the container forming step S2, the container forming step can also be carried out after the step for perforating fine permeable pores in the film material.

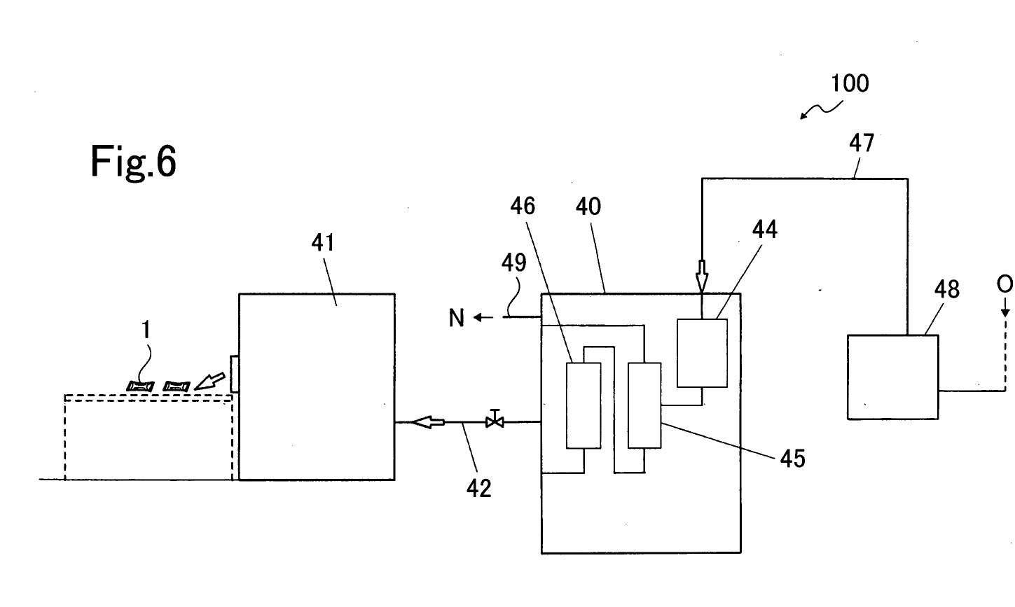

FIG. 6 shows a general view of ozone emitter production equipment 100 for producing the ozone emitter by carrying out each production step described above.

As shown in FIG. 6, the ozone emitter production equipment 100 is provided with an ozonizer 40 serving as an ozone generator and container production equipment 41 serving as a forming machine for forming the film material in a container shape. The ozonizer 40 and the container production equipment 41 are connected by an ozone conduit 42. The ozone conduit 42 is provided with an ozone filling nozzle 43 for filling ozone gas generated by the ozonizer 40 into a film container produced by the container production equipment 41. The ozone filling nozzle 42 serves as a filler.

The ozonizer 40 is provided with a compressor 44, a nitrogen separator 45, and a silent electric discharge ozone generator 46. The ozonizer 40 is connected to an air cooler 48 through an air conduit 47. The air cooler 48 is adapted to cool air 0 as a raw material to generate the ozone in a high concentration.

In other words, the ozone generating step S1 is carried out by the air cooler 48 and the ozonizer 40, the container forming step S2 is carried out by the container production equipment 41, and the ozone filling step S3 is carried out by the ozone conduit 42, respectively.

In the ozone generating step S1, air cooled by the air cooler 48 is sent to the compressor 44 through the air conduit 47. The air is compressed by the compressor 44 and then sent to the nitrogen separator 45. In the nitrogen separator 45, the nitrogen is separated from the air sent from the compressor 44 and substantially pure oxygen obtained by separating the nitrogen from air is sent to the silent electric discharge ozone generator 46. The nitrogen N separated in this manner is discharged from an exhaust pipe 49. The silent electric discharge ozone generator 46 generates ozone gas from the pure oxygen sent from the nitrogen separator 45, wherein the ozone gas is sent to the container production equipment 41 through the ozone conduit 42.

In order to generate the ozone in a high concentration, it is better to cool the air as the raw material. The air cooler 48 is therefore installed to generate ozone gas of a high concentration. In the case where ozone gas of high concentration is not required, it is not always necessary to install the air cooler 48.

It is desirable that the air as the raw material be cooled up to 5° C. by the air cooler 48. Further, in order to efficiently generate the ozone, it is desirable that the air as raw material be compressed to 0.3 Mpa˜0.5 Mpa by the compressor 44.

The present ozone emitter production equipment 100 is provided in such a manner that, in the container production equipment 41 and the ozone filler, the generated ozone gas can be quickly filled into the film container to effectively prevent the leakage of ozone gas. In other words, in the container production equipment 41, the film material with permeable pores 50 as the raw material is installed in a roll shape and the film is pulled out from the film material with the permeable pores 50 in a flat sheet shape. The film pulled out in this manner is folded into two in the pulling direction and the three open sides are sealed. The ozone filler is designed to fill ozone before one of the three sides is sealed. There is a high risk of ozone leaking during filling, but in the ozone emitter production equipment according to the present embodiment, the ozone filling nozzle 43 in the ozone filler is designed to effectively prevent ozone from leaking into the air during filling. The ozone emitter production equipment 100 will be described in detail below.

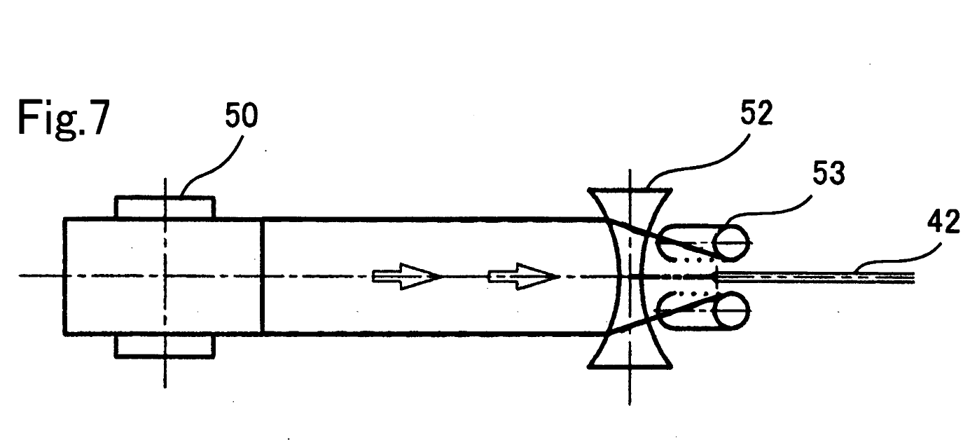

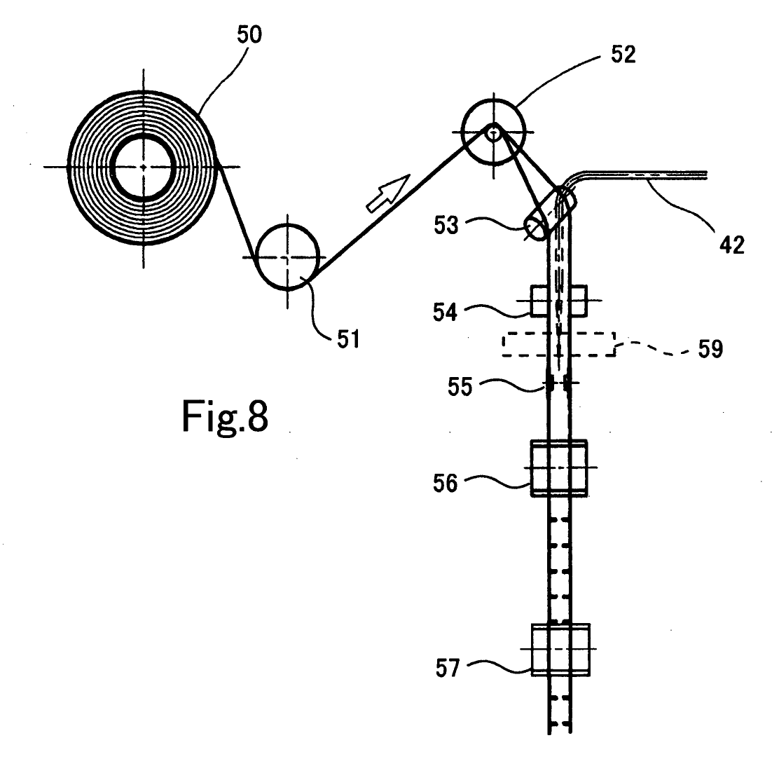

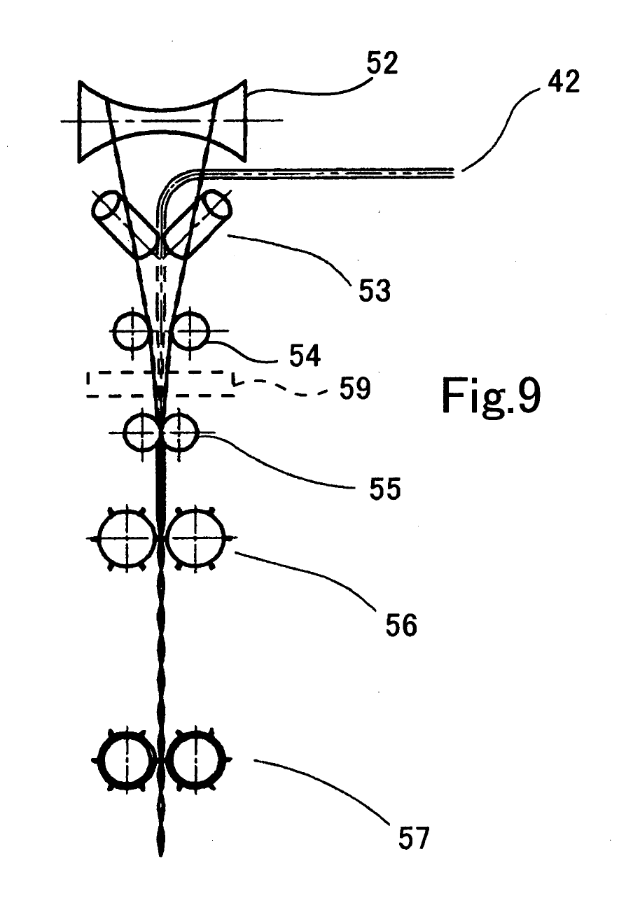

Ozone sent out of the ozonizer 40 through the ozone conduit 42 is sent to the container production equipment 41. FIGS. 7 through 9 are explanatory views, in the container production equipment 41, showing the steps for forming the film with permeable pores 50 in a container shape and for filling ozone into the film container. FIG. 7 shows a partial plan view of the container production equipment 41, FIG. 8 shows a partial side view of the container production equipment 41, and FIG. 9 shows a partial front view of the container production equipment 41, respectively. As shown in FIGS. 7 through 9, in the container production equipment 41, the film material with permeable pores 50, in which fine pores are perforated to be provided in a roll shape, is sent to an arched roller 52 through a guide roller 51 and is bent substantially at a right angle from the arched roller 52. The film material with permeable pores 50 is then sent along guide rollers 53, 54 to be folded into two in the direction of travel and is formed in a shape which is a prototype of a bag shape. A seal roller 55 serves as a vertical seal roller for sealing the film material with permeable pores 50 in the vertical direction, a seal roller 56 serves as a lateral seal roller for sealing the film material 50 in the lateral direction, and a roller 56 serves as a roller for perforating the film material and for cutting the film material 50 at a suitable location. The seal rollers 55 and 56 are adapted to seal the film material 50 at a suitable location to carry out a function for forming a desired number of cells.

The film material with permeable pores 50 is provided in such a manner that the two opposing faces are moved in the direction to approach one another with a central focus on the section folded by the guide rollers 53, 54 and are sealed in the vertical direction and in the lateral direction by the seal rollers 55, 56. However, ozone gas must be filled into the film container before the sealing process is completed. In the case where ozone is liquid, if filled from the top, it does not spill out by gravity. However, ozone forms the atmosphere in this case. In the case where the ozone filling nozzle 43 is formed in a circular shape in section, if the ozone filling nozzle 43 is inserted into the film material with the two opposing faces, it is unavoidable that a gap be produced on both ends of the ozone filling nozzle 43 and there is a high risk of ozone escaping from the gap. In the case where ozone has escaped, there is a possibility that electronic circuits and the like will corrode due to the strong oxidizing power of the ozone, causing the production equipment to break down. It is therefore necessary to maintain the ozone leakage as low as possible.

In the present embodiment, the front end of the ozone filling nozzle 43 provided on the end of the ozone conduit 42 to fill ozone into the film container is formed in a flat shape of which the end is sharp at an acute angle. By controlling the gap produced when the ozone filling nozzle 43 is inserted into an opening in the container to be as small as possible, leakage of ozone when filling the ozone is kept as low as possible to prevent the electronic circuits and the like from corroding and being broken down.

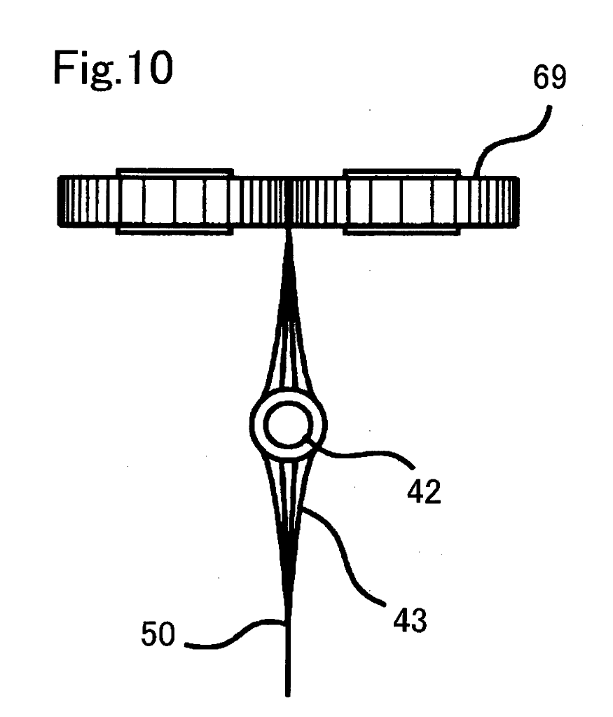

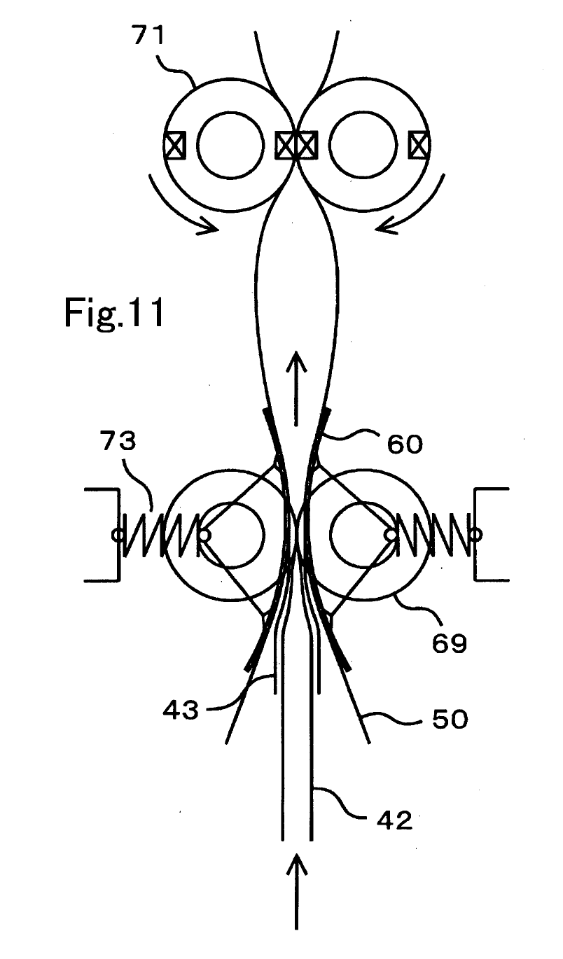

In the ozone emitter production equipment 100, the ozone filling nozzle 43 section of the ozone filler is a section where ozone easily leaks. An exploded explanatory view of an enclosed line section 59 in FIG. 8 is shown in FIG. 5. FIG. 10 is a plan view of the ozone filling nozzle 43 and FIG. 11 is a front view thereof. As shown in FIGS. 10 and 11, the ozone filling nozzle 43 is secured to the front end section of the ozone conduit 42 and is designed to have a special shape for guiding the ozone gas sent from the ozone conduit 42 to the inside of the film. The front end section of the ozone filling nozzle 43 is formed in a shape which follows the inner surface of the film with permeable pores 50 which travels while being folded into two, in other words, in a flat shape of which both ends are shaped at an acute angle in section, wherein the gap formed by inserting the ozone filling nozzle 43 into the inside of the film material with permeable pores 50 is controlled to be as small as possible, thereby controlling the leakage of ozone to be as low as possible. The nozzle end can be formed in a shape which can follow the inner surface of the film material and can be formed in an ellipsoidal shape in section or in an almond shape in which each circular arc is caused to face substantially symmetrically.

As shown in FIG. 11, the film material with permeable pores 50 is continuously sent along both sides of the ozone filling nozzle 43, but the film material with permeable pores 50 does not simply follow both sides of the ozone filling nozzle 43. If a roll-shaped or arcuate guide plate 60 is annexed to the outside of the ozone filling nozzle 43 and the film material with permeable pores 50, the film material with permeable pores 50 is inserted between the guide plate 60 and the ozone filling nozzle 42 to closely contact the ozone filling nozzle 43, thereby reducing the gap produced between the ozone filling nozzle 42 and the film material with permeable pores 50, and as a result, the ozone leakage can be minimized. In this case, since the ozone filling nozzle 43 and the guide plate 60 are not affected by ozone, Teflon (registered trademark) material, which has good slide characteristics and the like are desirable.

The guide plate 60 is provided in such a manner that it can be adequately depressed by a spring 73 from both sides. The guide plate 60 also improves the contact between the ozone filling nozzle 43 and the film material with permeable pores 50 to prevent ozone leakage. The open ends of the film material with permeable pores 50 folded into two are continuously sealed by a roll heater 69 provided on top of the ozone filling nozzle 43. The film container into which ozone gas is filled and sealed in this manner is sent to a seal roller 71 in a bulging condition, wherein three sides are sealed to complete the ozone emitter 1. Thus, it is possible to obtain the ozone emitter 1 which is effectively available as a buffer material.

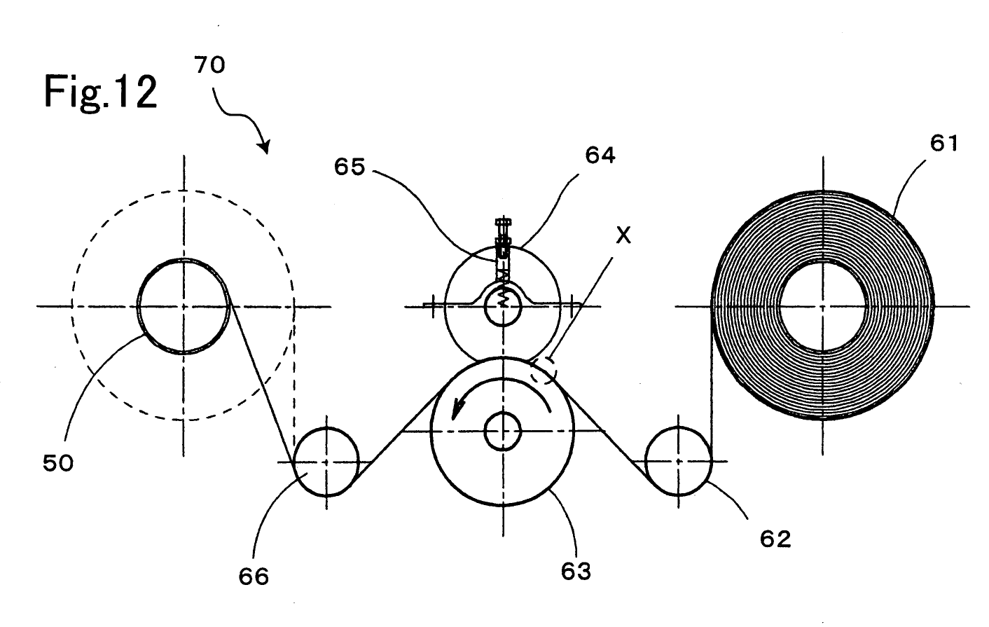

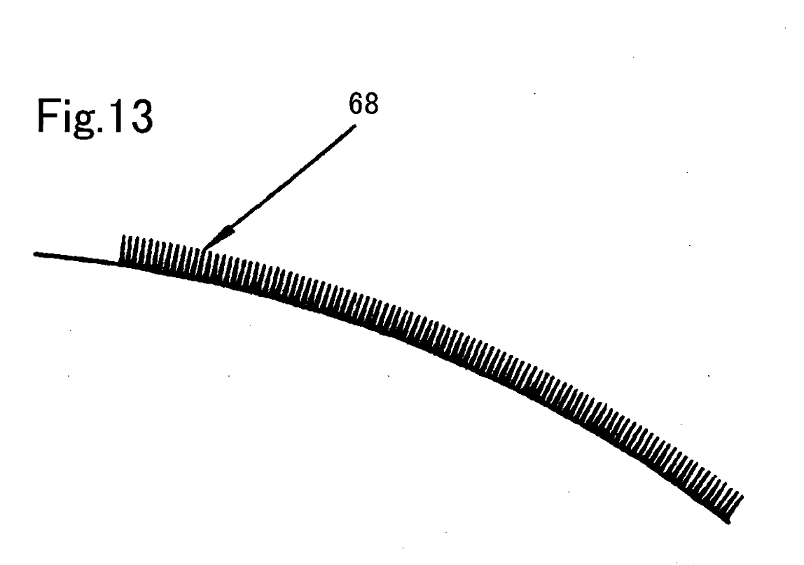

In the ozone emitter production equipment 100, a perforator 70 for perforating fine permeable pores in the film material can also be provided. FIG. 12 is an explanatory view showing the perforator 70. As shown in FIG. 12, the perforator 70 is provided in such a manner that a film material 50 as a raw material is installed in a roll shape and the film material 50 drawn out from the roll is sent to a porous roller 63 through a tension roller 66. FIG. 13 is an enlarged explanatory view showing a surface section X of the porous roller 63. As shown in FIG. 13, the surface of the porous roller 63 is provided with fine needle crystals 68 of a micron level. When the film material 50 is sent to the porous roller 63, the film material 50 is pressed toward the porous roller 63 by a pressure roller 64 which is disposed on top of the porous roller 63, wherein fine permeable pores are perforated in the surface of the film material 50. After the permeable pores are perforated in this manner, the film material 50 is rolled up in a roll shape as a film material with permeable pores 61 through a tension roller 62. The forward and backward movement of the pressure roller 64 is adjusted by a screw 65 and the pressure force can be adjusted by the degree of the forward and backward movement.

In the case where the sheet-shaped ozone emitter 1d as shown in FIG. 4 and the ozone emitter of which the size and capacity are larger than the ozone emitter 1d are produced, it is also considered that the seal rollers 55, 56 and the like are annexed to provide ozone emitter production equipment 100′ which can form multi-row cells. In this case, in order to realize such ozone production equipment 100′, each roller 51˜57 as shown in FIGS. 7˜11 can be extensively installed to meet the desired sheet width. A suitable number of vertical rollers and lateral rollers 55, 56 can also be installed to form a suitable number of cells. Further, a number of ozone conduits 42 can be installed.

It is to be noted that the film container forming the ozone emitter can be formed, for example, in a bag shape, a box shape, a belt shape, a spherical shape or other shapes in which these shapes are combined inasmuch ozone can be filled in the container and the container can be wrapped together with the objects to be sterilized and is not limited to a specified shape.

It will also be obvious to those skilled in the art that the ozone emitter production equipment described above is not limited to the embodiments described above and various changes may be made without departing from the spirit and technical scope of the present invention.

### EXAMPLES

A production method for an ozone emitter and an embodiment which is one example of the ozone emitter obtained from the production equipment will now be described below.

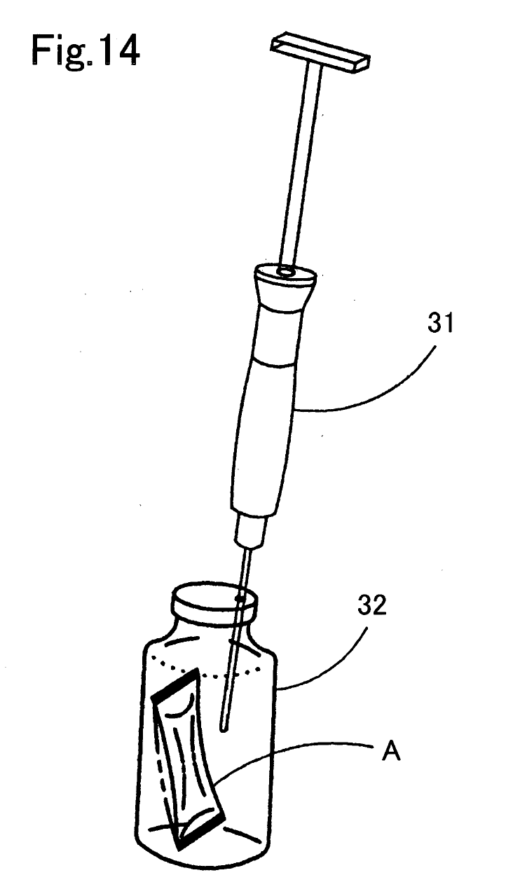

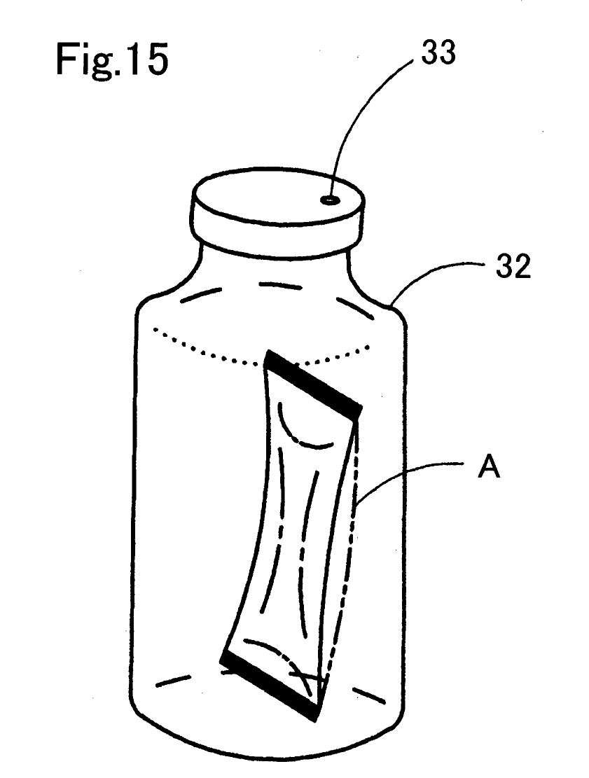

Polypropylene 40μ thick and polyester 12μ thick are laminated to form a film material. Permeable pores of about 15μ are then perforated in the film material in a density distribution of about 30 units/cm² to form a film material with permeable pores. The film material with permeable pores is formed in a container shape using the container production equipment of the ozone emitter production equipment. Ozone gas 50 cc at a concentration of about 7000 ppm generated by the ozone generator is filled and sealed in the formed container by an ozone filler to form an ozone emitter. In the present embodiment, as shown in FIGS. 14 and 15, an ozone emitter A having one cell is formed.

It is known that a practical ozone concentration to be used for sterilizing is about 0.5 ppm or more. As a result of testing, it is confirmed by the following experiments using the ozone emitter A that, if the pore has a diameter of about 5˜15μ, an adequate amount of ozone is emitted from the permeable pores and the effective emission can be continued for a long time.

FIGS. 14 and 15 are explanatory views showing the embodiments of the test for measuring the relationship between the elapsed time and the ozone concentration within an airtight container in which the ozone emitter A is disposed. As shown in FIGS. 14 and 15, in this test, the ozone emitter A is disposed within a glass bottle 32 with a volume of 500 cc of which the volume ratio about ten times larger than the ozone emitter A, and the elapsed time and the ozone concentration within the glass bottle 32 are measured by an ozone gas detector 31 to test the transition of the ozone concentration over the passage of time.

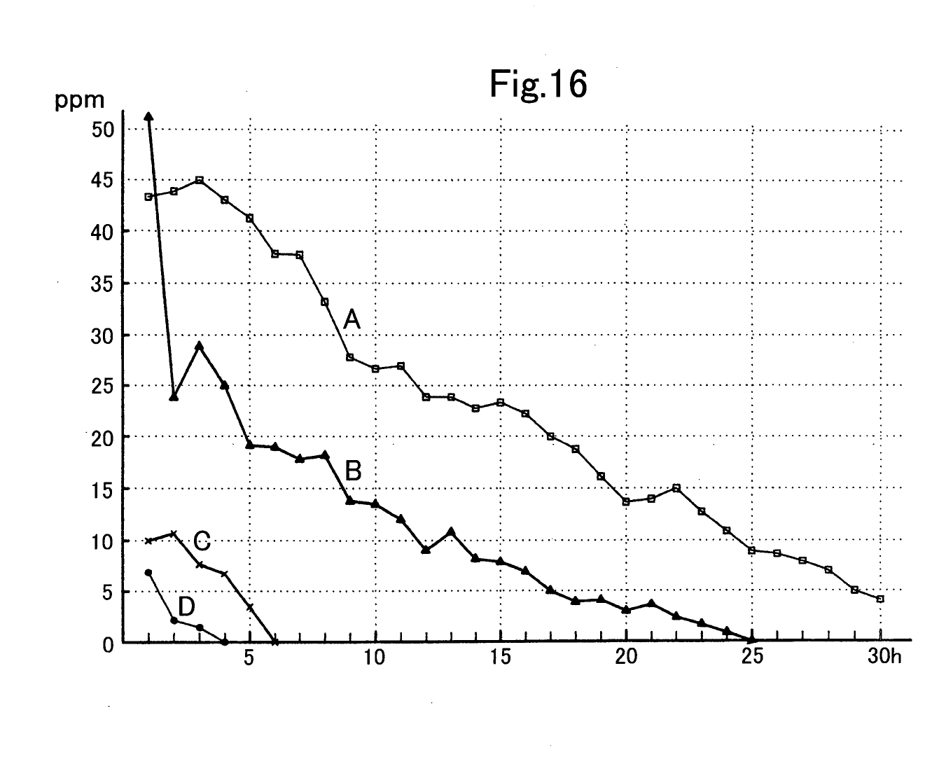

The ozone concentration within the glass bottle 32 after passage of a given length of time was measured by the ozone detector 31 and the measurement results are shown in FIG. 16. In FIG. 16, the horizontal axis shows the elapsed time and the vertical axis shows the ozone concentration. The line A of FIG. 16 shows the transition of ozone concentration using the ozone emitter A as a test piece, wherein a concentration of 43 ppm after 2 hours and a concentration of 4 ppm after 30 hours were measured.

Likewise, the line B shows another test carried out using a film container having the same material and the same shape as in the ozone emitter A, wherein the size of the permeable pores is about 10μ, the density distribution of the pores is about 30 units/cm² as seen in the first test, and an ozone emitter B is used as a test piece, of which the container is filled with the ozone gas 50 cc of a concentration of about 7000 ppm. As shown in FIG. 16, a higher ozone concentration than from the ozone emitter A was measured after 1 hour of the test, but the line B generally kept the ozone concentration level lower than the ozone emitter A. The ozone concentration was detected for 25 hours.

In the line C, a test was conducted using a film container having the same material and the same shape as in the ozone emitter A, wherein permeable pores with the diameter of about 6μ are perforated in the film container, the density distribution of the pores are about 80 units/cm², and an ozone emitter C is used as a test piece, of which the film container is filled with ozone gas 50 cc of a concentration of about 7000 ppm. It is difficult for the ozone emitter C to permeate ozone. Ozone concentration was detected for 6 hours, but the maximum concentration was 10 ppm.

Likewise, the line D also shows the measurement results carried out using an ozone emitter D consisting of a film container having the same material and formed in the same shape as the ozone emitter A. The ozone emitter D is perforated with fine pores of a diameter of about 3μ, of which the density distribution is 50 units/cm2. Ozone gas 50 cc of a concentration of about 7000 ppm is filled into the bag to form the ozone emitter D. According to the test results, the ozone concentration was 7 ppm after 1 hour of the test. The concentration declined later and became zero after 4 hours. In the case of this pore diameter, favorable emission could not be obtained even though the number of pores was increased.

The permeable pores are perforated in the whole area or part of the surface of each ozone emitter A through D. It is found that the larger the permeable pores, the more the emitted ozone gas and the faster the discharge (emission) rate, and the holding time of the ozone gas in the installed container can be maintained to act effectively. On the contrary, it is also found that the smaller the permeable pores, the less the permeable amount and the slower the permeation, and the holding time of ozone gas in the installed container is shortened. In other words, the discharge rate and the holding time of ozone gas can be adjusted by adjusting the size and density distribution of the pores. It is possible to keep ozone gas for a long time if kept at a low temperature in view of the properties of ozone.

In the case where the ozone emitter formed by filling ozone gas of which the ozone concentration is about 5000 ppm into the film container is kept at a temperature of 5° C., it took 24 hours or more for the ozone gas to be decomposed to become a concentration of 1 ppm. In this manner, if ozone of a high concentration of 5000˜10000 ppm is filled into the film container to form the ozone emitter and the ozone emitter is put in a container of which the capacity is about 10 times larger than the ozone emitter, it is confirmed that the ozone concentration in the container can be kept between 50 and 1 pp for a long time. However, taking the adverse effect, whereby oxidization and the like of food, depending on the type of food, is generated, into consideration, it is desirable that the ozone concentration be between 1 ppm and 100 ppm.

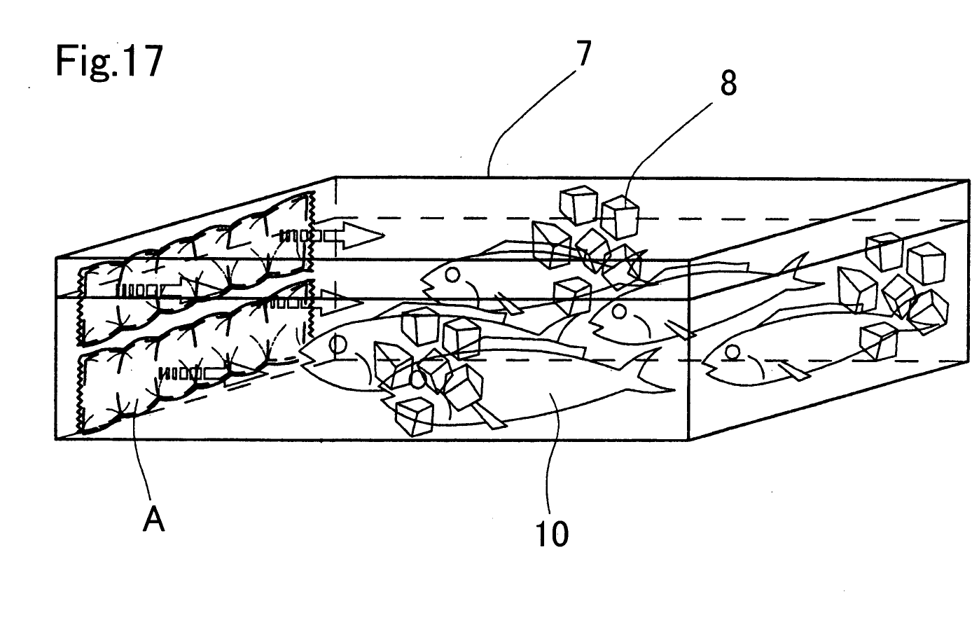

FIG. 17 shows an embodiment of a sterilizing and deodorizing test by the ozone emitter “A” conducted by containing the ozone emitter A, ice 8 and fish 10 in a polystyrene foam carton 7. As shown in FIG. 17, the volume ratio of the ozone emitter A as a test piece and the polystyrene foam carton 7 is set at about 10 times. The ozone emitter A is secured to an inner wall surface of the foam carton 7 and fish 10 is housed in the foam carton 7. For comparison, fish 10 is also housed in another foam carton 7, in the same condition, in which the ozone emitter A is not disposed. As a result of a comparison of the freshness condition between the fish in two cartons after 48 hours, the number of bacteria developed on the surface of the fish was reduced by about ⅛ to 4.2×10³ from 3.4×10⁵ in the fish 10 in the condition in which the ozone emitter A is disposed, and the smell peculiar to the fish was reduced as well.

In order to keep the proper ozone concentration in the container which has a capacity 10 times larger than the ozone emitter, it is found from the test that the diameter of permeable pores can be properly adjusted between 5 and 20μ and the density distribution can be adjusted between 10 and 5/cm². It is also found in gaseous ozone that the higher the humidity and the temperature, the stronger the oxidizing power and the stronger the bactericidal effect. However, this does not mean that the higher the humidity and the temperature, the higher the effect, but there is an upper limit to the bactericidal effect and the ozone is instantaneously decomposed at a temperature of 200° C.

A sterilizing test was conducted to measure the number of existing bacteria (viable cell account) over the elapsed time using vegetables, which can be humidified, as an object to be sterilized by the ozone emitter. The test results are shown in Table 1.

The objects to be sterilized are precut cabbages and eggplants. Three ozone emitters E˜G are prepared (E: Ozone emitter without perforation; F: Ozone emitter with a pore diameter of about 8μ; and G: Ozone emitter with a pore diameter of about 15μ), wherein ozone with a concentration of 7000 ppm is filled into a film container which is formed by a film material with permeable pores of which the density distribution is about 30 units/cm². The surface of cabbage to be used for the test is sprayed with a little water. The test for measuring the number of bacteria was carried out under storage conditions of 5° C. As a result of the test, the number of bacteria reduced by triple digits and an extremely favorable result was confirmed. Even in the case of the eggplant, the number of bacteria is extremely reduced as shown in Table 1. In particular, the ozone emitter G with the pore diameter of 15μ has a very high effect and this shows that such an ozone emitter is very effective in sterilization of the vegetables.

TABLE 1
Sterilizing test

| | | Viable bacteria (Viable cell count) [/g] | |
|---|---|---|---|
| Objects to be sterilized | | At the start | After 24-hour storage |
| Precut | Ozone emitter E | 5.7 × 10⁴ | 1.6 × 10⁵ |
| cabbage | Ozone emitter F | 6.1 × 10⁵ | 8.4 × 10³ |
| | Ozone emitter G | 8.1 × 10⁵ | 5.9 × 10² |
| Precut | Ozone emitter E | 1.2 × 10⁴ | 9.2 × 10⁴ |
| eggplant | Ozone emitter F | 6.6 × 10³ | 3.6 × 10² |
| | Ozone emitter G | 7.9 × 10³ | 300 or less |

Storage condition: +5° C. in a refrigerator
Pore diameter (μm) × Distribution number (cm²)
Ozone emitter E = No perforation
Ozone emitter F = 8 μm × 30
Ozone emitter G = 15 μm × 30

Next, a test for measuring the ozone permeability was carried out using ozone emitters formed by a film material of which the raw material is different. As a measuring object for this test, an ozone emitter H is used: A film material formed by laminating polypropylene and nylon is perforated with fine permeable pores of a diameter of about 15μ to provide a film container of which the density distribution of the pores is 30 units/cm2. Ozone 50 cc of a high concentration of about 5000 ppm is filled into the film container to form the ozone emitter H.

The ozone emitter H is housed in an airtight container of a capacity of 500 cc which is 10 times larger than the ozone emitter H, and transition of ozone concentration within the container was tested. The measuring method is the same as that shown in FIGS. 14 and 15.

As a result of this measurement, the ozone concentration within the airtight container shows 10 ppm after 2 hours of the test and became zero after 6 hours. As a result, it is found that the nylon material is affected by the temperature and the humidity after the permeable pores are formed, nylon swells to reduce the diameter of the permeable pores, thereby reducing the amount of ozone permeation. In this manner, it is found that, even though a perforation process is conducted, ozone permeability varies with the material of the film and predicted value cannot be obtained.

In the case where gas is emitted from the inside of the film container to the outside thereof as in the ozone emitter according to the present invention, it is usually considered that gas cannot be emitted unless air pressure within the container is more than atmospheric pressure. However, according to the following tests, it is confirmed that, in the case where ozone is housed in the film container at a pressure substantially equivalent to atmospheric pressure, in other words, even if there is no difference in pressure between the inside and the outside, gas naturally diffuses outside and mixes with the air. As a test method, the same test as that shown in FIGS. 14 and 15 was carried out. In other words, an ozone emitter I into which ozone is filled at normal pressure to the extent of 30% of the total capacity of the film container, is disposed within the airtight glass bottle 32. After passage of the predetermined time, gas within the glass bottle 32 was removed using the gas detector 31 to measure the ozone concentration within the glass bottle 32. As a result, ozone gas was detected. It is recognized that ozone is emitted outside the film container even if the pressure within the film container is kept at a substantially normal pressure. Further, since the ozone within the film container is substituted for external air and mixed therein, reduction of volume within the film container of the ozone emitter was not confirmed after test. Oxygen concentration within the glass bottle 32 increased to the extent of 40% (of the total capacity).

In the case where the present ozone emitter is used, the ozone emitter can only be disposed together with the objects to be sterilized such as fresh food. However, if the ozone emitter is especially used within a container which is almost airtight, a polystyrene foam carton and the like, it is difficult for the ozone to be diffused in the air and as a result, it is possible to fill ozone into the container and to maintain the freshness of the objects to be sterilized for a long time. Further, according to the present invention, since the ozone gas is directly filled into the container and sealed without filling the ozone into a secondary media such as ozone water and ozone ice, there is an advantage in that ozone gas with a high concentration can be filled at the production stage of the ozone emitter and the bactericidal effect can be improved.

In the above embodiments and examples, food products are exemplified as the object to be sterilized by the present ozone emitter, but the object is not limited to food, and this method can be widely applied to all other things that require sterilizing. For example, the present ozone emitter can also be effectively applied to sterilization and the like of medical equipment.

The present invention is described above through the embodiments and examples, but according to the present invention, it is possible to provide an ozone emitter which can continue to maintain a sterilizing (bactericidal) effect for a long time and which is easily portable. It is also possible to provide safe and effective equipment for producing the ozone emitter which could control ozone leakage to as low as possible when the ozone emitter is produced. Further, the ozone emitter can be effectively used as a buffer material to protect the object to be sterilized from possible shock and to effectively sterilize such an object.

1. An ozone emitter comprising a container filled with ozone gas, the container comprising a film of an ozone gas impermeable film material, the film having pores permeable to the ozone gas.

2. The ozone emitter according to claim 1, wherein the container has an internal volume of 1 cc ˜1000 cc and a concentration of the ozone gas in the container is 1000 ppm˜10000 ppm.

3. The ozone emitter according to claim 1, wherein the container is comprised of at least one cell.

4. The ozone emitter according to claim 3, wherein an internal volume of each cell is 1 cc˜50 cc.

5. The ozone emitter according to claim 1, wherein thickness of the film is 10˜100μ.

6. The ozone emitter according to claim 1, wherein the film material is a plastic film material of which the basic ingredient is at least one of polypropylene, polyethylene, polyvinyl chloride or polyester.

7. The ozone emitter according to claim 1, wherein the film is a single layer film or a multi-layer film which is a laminate of at least two film layers.

8. The ozone emitter according to claim 1, wherein the diameter of the permeable pores is 5˜50μ.

9. The ozone emitter according to claim 1, wherein the pores number 1˜100 per 1 cm² of the film.

10. A method for producing an ozone emitter comprising the steps of:
generating ozone gas;
forming a single or plural cell container comprising a film of an ozone gas impermeable film material, the film having pores permeable to ozone gas; and
filling the ozone gas generated by the ozone generating step into the the container at substantially atmospheric pressure.

11. A method for producing an ozone emitter comprising the steps of:
generating ozone gas;
forming pores permeable to the ozone gas in a film material which is impermeable to the ozone gas;
forming the film having pores permeable to the ozone gas into a single or plural cell container; and
filling the ozone gas generated by the ozone generating step into said single or plural cells at substantially atmospheric pressure.

12. Apparatus for producing an ozone emitter comprising:
a forming machine for continuously fabricating containers comprising a film having ozone gas permeable pores and comprised of an ozone gas impermeable film material;
an ozone generator for generating ozone gas from oxygen in the air; and
a filler provided with a nozzle to be inserted into each said container for automatically filling the containers with the ozone gas generated by the ozone generator and hermetically sealing the ozone gas in the containers at substantially atmospheric pressure.

13. The apparatus for producing an ozone emitter according to claim 12, wherein the forming machine comprises a perforator for forming said pores in a film comprised of an ozone gas impermeable film material.

14. The apparatus for producing an ozone emitter according to claim 12, wherein an end of the nozzle to be inserted into the container for filling the ozone gas is of ellipsoidal shape or flat cross section of which each end forms a respective acute angle.

15. The apparatus for producing an ozone emitter according to any one of claims 12 through 14, wherein the forming machine comprises a sealing device for forming the container as one cell or a plurality of cells.

16.-17. (canceled)

18. A method according to claim 10, wherein the container comprises a plurality of cells.

19. A method of utilizing an ozone emitter of any one of claims 1 to 9, comprising placing the ozone emitter in a container containing food products of which freshness is to be prolonged or items of which sterility is to enhanced.
